(19) United States
(12) Patent Application Publication
(10) Pub. No.: US 2025/0116333 A1
(43) Pub. Date: Apr. 10, 2025

(54) RAIL FASTENER SEALING SYSTEMS AND METHODS FOR SEALING A RAIL FASTENING ASSEMBLY

(71) Applicant: Jamak Fabrication-Tex LLC, Weatherford, TX (US)

(72) Inventors: James Scott FOWLER, Perrin, TX (US); Steve MEEKS, Mineral Wells, TX (US)

(73) Assignee: Jamak Fabrication-Tex LLC, Weatherford, TX (US)

(21) Appl. No.: 18/907,265

(22) Filed: Oct. 4, 2024

Related U.S. Application Data
(60) Provisional application No. 63/542,515, filed on Oct. 4, 2023.

(51) Int. Cl. F16J 15/3204; E01B 9/10

(52) U.S. Cl. CPC F16J 15/3204; E01B 9/10; E01B 2201/04

(57) ABSTRACT

A rail fastener sealing system comprises a dowel having a substantially cylindrical elongated body and a dowel passage configured to receive a fastener that secures a rail to a rail tie. The sealing system further includes a seal positioned on an end of the dowel. The seal includes a flexible body having a central passage extending through the flexible body and a lip extending circumferentially around an opening of the central passage. The lip of the seal is disposed adjacent the end of the dowel and at least a portion of the flexible body of the seal is positioned within the dowel passage.

### CROSS-REFERENCE TO RELATED APPLICATIONS

This application claims the benefit of and priority to U.S. Provisional Application No. 63/542,515, filed on Oct. 4, 2023, which is hereby incorporated by reference in its entirety.

### TECHNICAL FIELD

The present disclosure relates generally to the field of rail transportation, and more particularly to the sealing of fastener systems used to fasten and secure rails to a rail tie or other support.

### BACKGROUND

For vehicles that operate on rails such as trains, subways, trams, trolleys, and rail carts, a pair of parallel rails are typically provided that bear the weight of the rail-based vehicle and provide a directional path for travel. Since rail-based vehicles and their loads are often heavy, it is crucial that a firm foundation be provided beneath the rails. For rails installed in both outdoor and indoor environments, the rails are often positioned on a bed of rail ties that are laid perpendicular to the rails and supported by a base of rocks, gravel, sand, or another compactable material. Rail ties may be made from large timbers that have been treated with creosote, but in some designs, the rail ties may be made from concrete, polymers or other strong materials that are resistant to weather and moisture. The rails are positioned atop the rail ties and joined to the rail ties. Joining the rails to the rail ties prevents excessive movement of the rails during the passage of a rail-based vehicle and also maintains the spatial distance between the rails. The rail fastening assembly that joins the rail to each tie may vary somewhat depending on the type of rail tie, but often the assembly includes a bolt or other fastener that penetrates the rail tie and secures the rail to the rail tie.

### BRIEF DESCRIPTION OF THE DRAWINGS

Illustrative examples of the present disclosure are described in detail below with reference to the attached drawing figures, which are incorporated by reference herein, and wherein:

FIG. 1 illustrates a front cross-sectional view of a rail fastener sealing system according to an embodiment taken at 1-1;

FIG. 2 illustrates a top view of the rail fastener sealing system of FIG. 1;

FIG. 3 illustrates an enlarged front cross-sectional view of the rail fastener sealing system of FIG. 1;

FIG. 4 illustrates a front cross-sectional view of a rail tie and dowels of a rail fastener sealing system according to an embodiment;

FIG. 5 illustrates an isometric front view of a rail fastener sealing system according to an embodiment;

FIG. 6 illustrates a top view of the rail fastener sealing system of FIG. 5;

FIGS. 7A and 7B illustrate a cross-sectional front view taken at 7A-7A and an enlarged front view of an embodiment of the rail fastener sealing system of FIG. 5;

FIGS. 8A and 8B illustrate a cross-sectional front view taken at 8A-8A and an enlarged front view of an embodiment of the rail fastener sealing system of FIG. 5;

FIG. 9 illustrates an isometric front view of a rail fastener sealing system according to an embodiment;

FIG. 10 illustrates a top view of the rail fastener sealing system of FIG. 9;

FIGS. 11A and 11B illustrate a cross-sectional front view taken at 11A-11A and an enlarged front view of an embodiment of the rail fastener sealing system of FIG. 9;

FIGS. 12A and 12B illustrate a cross-sectional front view taken at 12A-12A and an enlarged front view of an embodiment of the rail fastener sealing system of FIG. 9;

FIG. 13 illustrates an isometric front view of a rail fastener sealing system according to an embodiment;

FIG. 14 illustrates a top view of the rail fastener sealing system of FIG. 13;

FIGS. 15A and 15B illustrate a cross-sectional front view taken at 15A-15A and an enlarged front view of an embodiment of the rail fastener sealing system of FIG. 13;

FIG. 16 illustrates a bottom view of the rail fastener sealing system of FIG. 13;

FIGS. 17A and 17B illustrate a cross-sectional front view taken at 17A-17A and an enlarged front view of an embodiment of the rail fastener sealing system of FIG. 13;

FIG. 18 illustrates an isometric front view of a rail fastener sealing system according to an embodiment;

FIG. 19 illustrates a top view of the rail fastener sealing system of FIG. 18;

FIGS. 20A and 20B illustrate a cross-sectional front view taken at 20A-20A and an enlarged front view of an embodiment of the rail fastener sealing system of FIG. 18;

FIG. 21 illustrates a bottom view of the rail fastener sealing system of FIG. 18; and

FIGS. 22A and 22B illustrate a cross-sectional front view taken at 22A-22A and an enlarged front view of an embodiment of the rail fastener sealing system of FIG. 18.

The illustrated figures are only exemplary and are not intended to assert or imply any limitation with regard to the environment, architecture, design, or process in which different examples may be implemented.

### DETAILED DESCRIPTION

In the following detailed description of several illustrative examples, reference is made to the accompanying drawings that form a part hereof, and in which is shown by way of illustration specific examples that may be practiced. These examples are described in sufficient detail to enable those skilled in the art to practice them, and it is to be understood that other examples may be utilized, and that logical structural, mechanical, electrical, and chemical changes may be made without departing from the spirit or scope of the disclosed examples. To avoid detail not necessary to enable those skilled in the art to practice the examples described herein, the description may omit certain information known to those skilled in the art. The following detailed description is, therefore, not to be taken in a limiting sense, and the scope of the illustrative examples are defined only by the appended claims.

In the following discussion and in the claims, the terms “including” and “comprising” are used in an open-ended fashion, and thus should be interpreted to mean “including, but not limited to.” Unless otherwise indicated, as used throughout this document, “or” does not require mutual exclusivity.

Rail fastener sealing systems and methods for sealing a rail fastening assembly are described according to the following illustrative embodiments. The systems and methods described herein address the issue of moisture and contaminants invading the fasteners and fastening systems used to join rails and rail ties. With continued exposure to the environment and frequent vibration caused by passing vehicles, these fastening systems are often exposed to the corrosive effects of dirt, sand, acid rain and other substances and liquids that penetrate the joint between the fastener and the rail tie. In some rail systems, such as for example those rail systems with concrete ties, a dowel or sleeve is often inserted into the concrete tie to cradle and receive the bolt or other fastener. This sleeve may exacerbate the issue of corrosion and exposure. In the present disclosure, sealing systems are provided that seal between such a sleeve and the fastener to prevent or reduce ingress of water or other liquids, dirt, sand and other debris or contaminants.

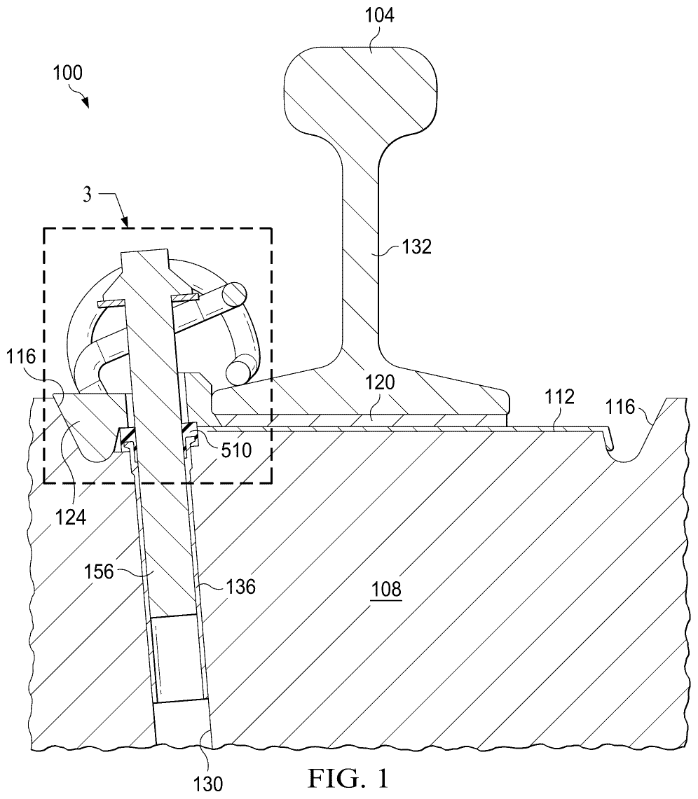

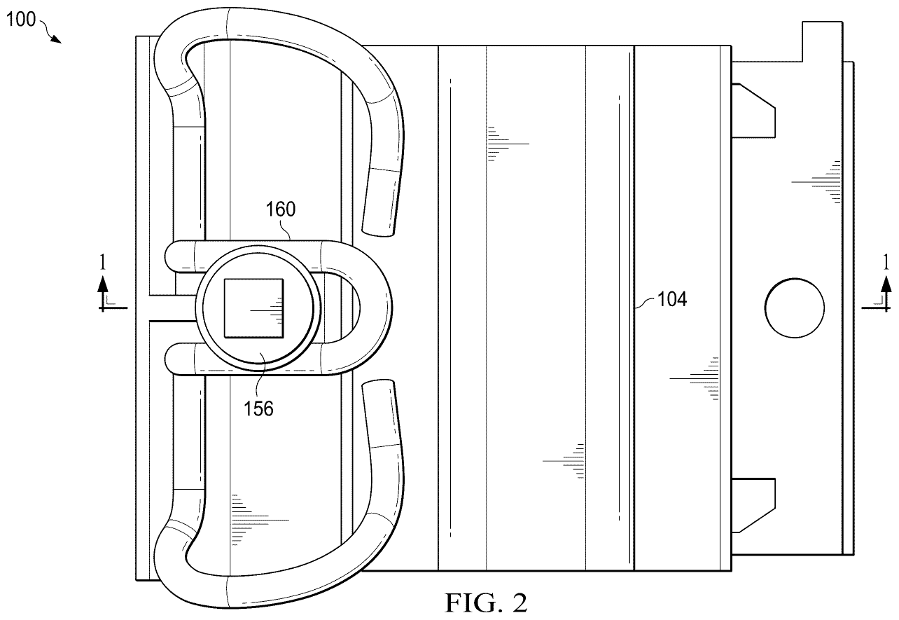

Referring to FIGS. 1-3, a rail fastener sealing system 100 according to an illustrative embodiment is illustrated. As shown in FIG. 1, the rail fastener sealing system 100 includes a rail 104 positioned atop a rail tie 108. The rail tie 108 in some embodiments may include a recessed shelf 112 bordered on each end by a channel 116. The rail 104 is positioned on the recessed shelf 112, and a rail pad 120 may be positioned between the rail 104 and the recessed shelf 112. A guide plate 124 is positioned in each channel 116 and may abut the rail pad 120 such that the rail 104 may rest on both the rail pad 120 and the guide plate 124.

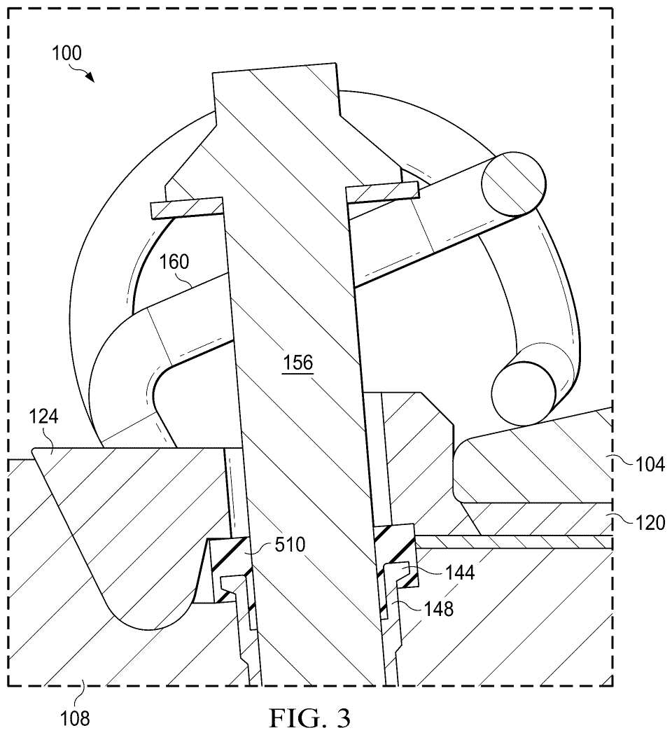

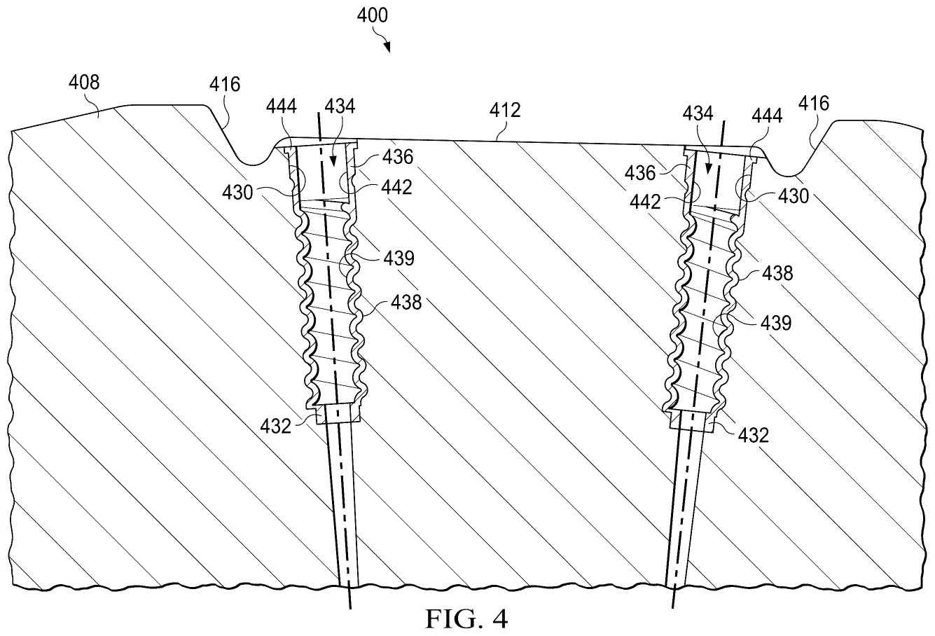

The rail tie 108 may include a hole 130 extending from the recessed shelf 112 into and through the rail tie 108. The axis of the hole may be angled (i.e., not parallel to) relative to a vertical web 132 of the rail 104. The hole 130 may be a drilled hole or instead may be molded or otherwise integrally formed into the rail tie 108, depending on the material from which the rail tie 108 is made. A dowel or sleeve 136 is positioned within each hole 130 and may be secured in the hole 130 by an adhesive or instead by threading the dowel 136 into the hole 130. The dowel 136 may include inner threads (see for example FIG. 4) at least partially formed within the dowel 136. The dowel 136 may also include an upper flange 144 that extends circumferentially around an opening of the dowel 136. A plurality of key extensions 148 may be disposed on an outer surface of the dowel 136 and extend radially outward from the outer surface. In other embodiments, a ridge or other protrusion (not shown) may be positioned on an end of the dowel 136 extending from the upper flange 144. In FIG. 3, the key extensions 148 illustrated are diametrically opposed and positioned 180 degrees from each other. Additional key extensions not shown in FIG. 3 may also be present on the dowel 136.

The opening of the dowel 136, when installed, aligns with a hole in the guide plate 124 to allow a fastener 156 such as a bolt to pass through the guide plate 124 and into the dowel 136. The fastener 156 engages a tension clamp 160 positioned above the guide plate 124. The tension clamp 160 may be constructed from spring steel such that the fastener 156, when tightened, pulls the tension clamp 160 into engagement with the rail 104 to secure the rail 104 to the rail tie 108.

The rail fastener sealing system 100 further includes a seal 510 to seal between the fastener 156, dowel 136, and the guide plate 124. The various embodiments of seals described herein may include a flexible body with components meant to engage the bolt or other parts positioned adjacent the dowel 136. Any of the seals described herein may be used in conjunction with the rail fastener sealing system 100. The flexible body in some embodiments may include recesses or channels meant to improve the positioning or securement of the seal relative to the dowel 136. For example, the flexible body may include keyways to receive the key extensions 148 of the dowel 136, or may instead include channels to receive ridges or other protrusions extending from an end of the dowel 136, which ensures that the flexible body is properly oriented on the dowel 136. The seal system cooperates with the dowel 136, fastener 156 and guide plate 124 to prevent or reduce the likelihood of dirt, dust, sand, moisture and other contaminants entering the dowel 136 and potentially compromising the fastener 156 over time.

FIG. 4 illustrates a front cross-sectional view of a rail tie 408 and dowels 436 of a rail fastener sealing system 400 similar to rail fastener sealing system 100. While the rail, guide plate and seal of the rail fastener sealing system 400 are not illustrated in FIG. 4, the rail tie 408 includes a recessed shelf 412 bordered on each end by a channel 416. The rail tie 408 may include a hole 430 extending from the recessed shelf 412 through the rail tie 408. The axis of the hole may be angled as described previously. In another embodiment the hole 430 may be positioned at an approximately perpendicular angle to the surface of the shelf 412. In the embodiment illustrated in FIG. 4, the hole 430 may include a plurality of threads 434. A dowel or sleeve 436 is positioned within each hole 430 and includes a cylindrical elongated body 432 forming a dowel passage 434. The dowel 436 may include a plurality of threads 438 on an exterior surface of the dowel 436 and also a plurality of threads 439 on an interior surface of the dowel 436 within the dowel passage 434. The dowel 436 may be secured in the hole 430 by threading the dowel 436 into the hole 430, but an adhesive may also be used to hold the dowel 436 in place after threading it into the hole 430. The inner threads 439 of the dowel 436 may be formed below an unthreaded portion 442 of the dowel passage 434. The dowel 436 may also include an upper flange 444 that extends circumferentially around an opening of the dowel 436 in some embodiments. In other embodiments, the dowel 436 may not include a flange but just an end surface that is not of greater thickness than that of the elongated body 432. Key extensions may be disposed on an outer surface of the dowel in a manner similar to those described in FIGS. 1-3, but in some embodiments, ridges or other protrusions may be positioned on an end surface or outer surface of the dowel 436 to engage a seal that is positioned between the dowel 436 and a fastener that is to be inserted into the dowel passage 434.

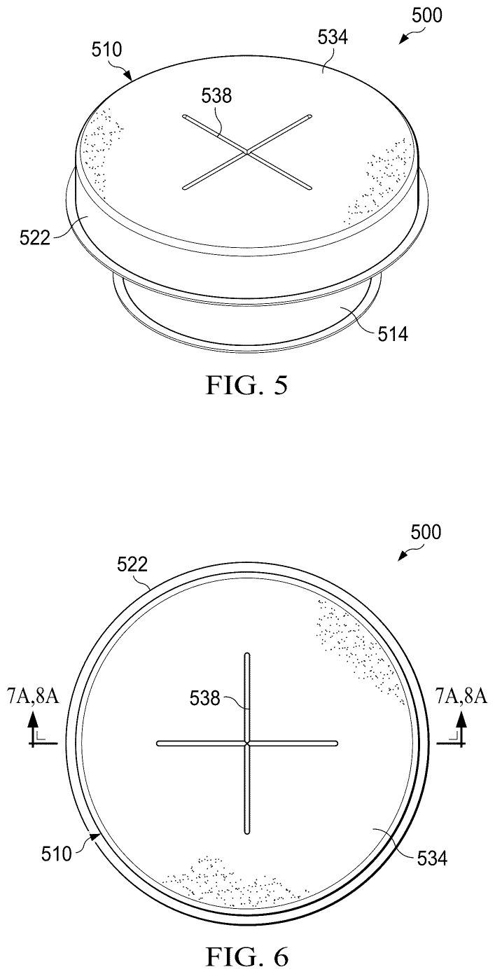

FIGS. 5 and 6 are an isometric front view and a top view, respectively, of a rail fastener sealing system 500 according to an embodiment. The rail fastener sealing system 500 may be a part of or cooperate with the other components of the rail systems described herein such as those in FIGS. 1-4. The rail fastener sealing system 500 includes seal 510 which includes a flexible body 514 having a central passage 518. The flexible body 514 may be substantially cylindrical in shape with a lip 522 extending circumferentially around an opening of the passage 518.

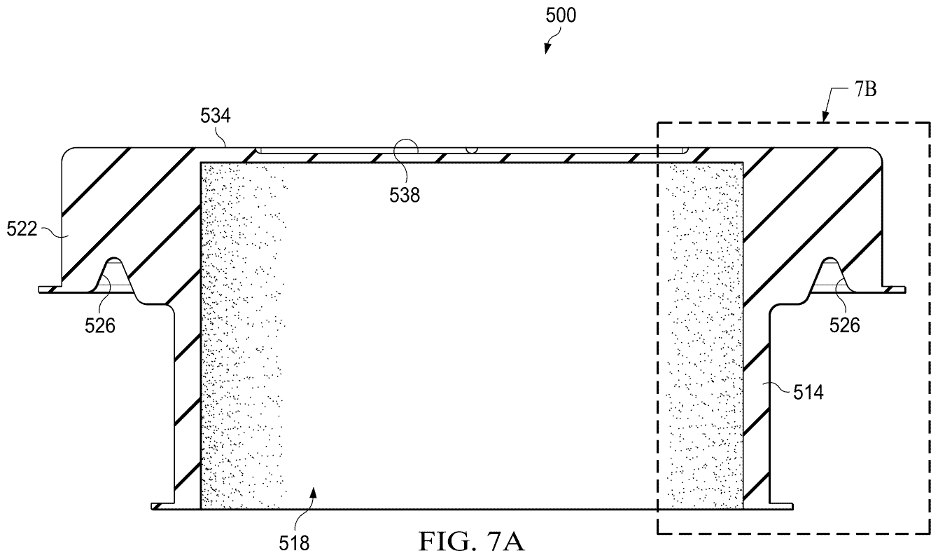

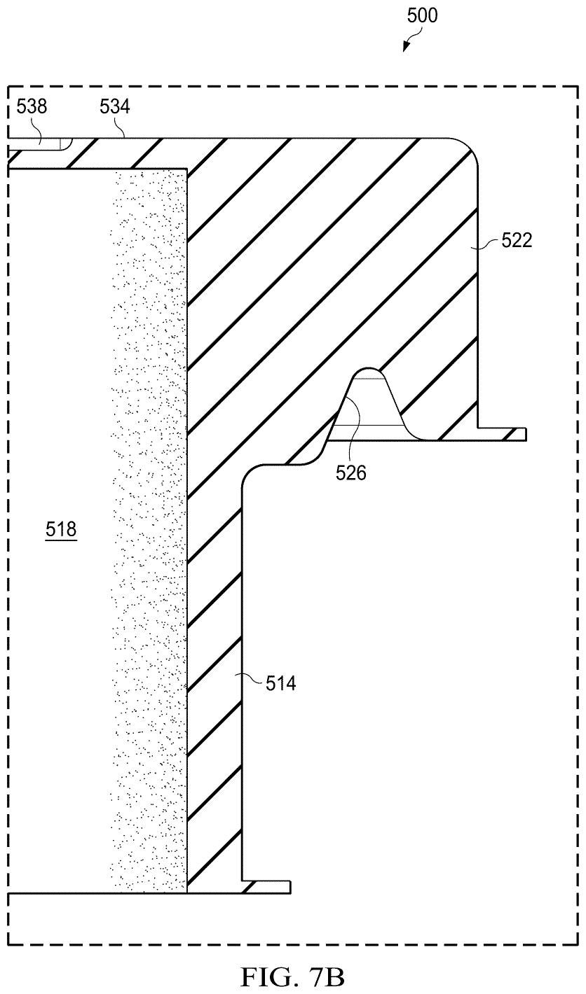

FIGS. 7A and 7B show cross-sectional front views of one embodiment of the lip 522 of seal 510. The lip 522 may include an inner channel 526 to receive a ridge or other protrusion that extends from an end surface of the dowel. The channel 526 may extend continuously and circumferentially around the lip 522, and may cooperate with the ridge or protrusions of the dowel to ensure the proper orientation of the seal 510 when installed on the dowel.

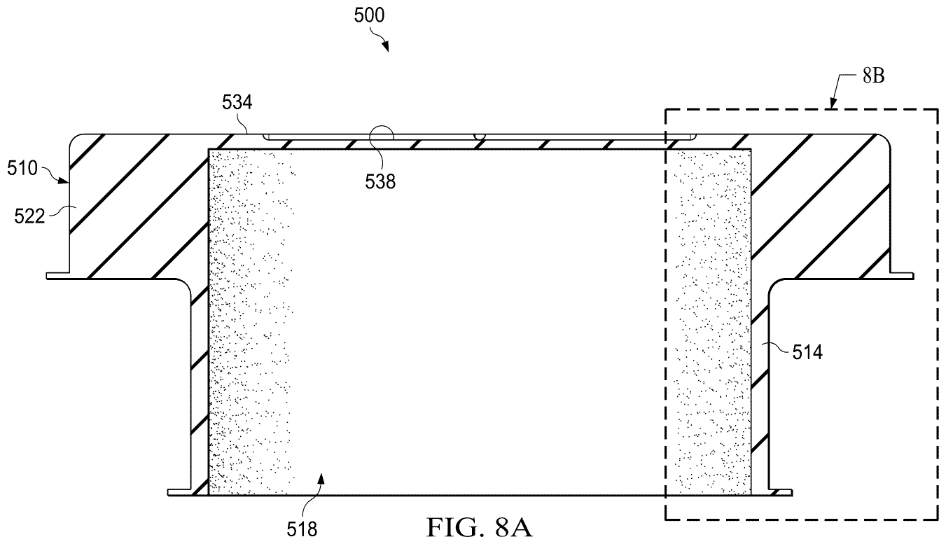

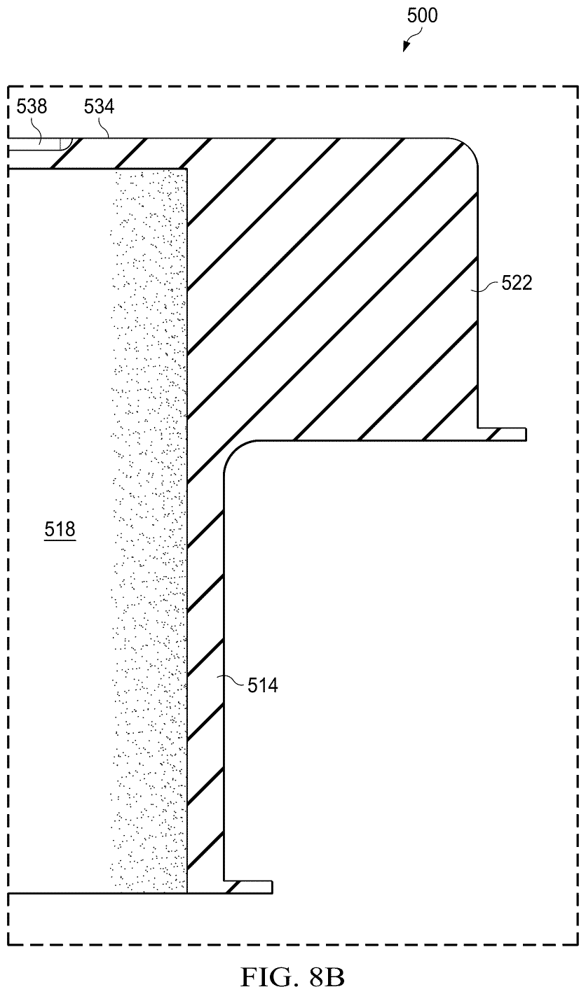

FIGS. 8A and 8B show cross-sectional front views of another embodiment of the lip 522 of seal 510. The lip 522 in FIGS. 8A and 8B does not include a channel or indentations and thus is meant to be used with dowels that do not have ridges, protrusions or other extensions to assist in orienting or positioning the seal 510 on the dowel.

Referring still to FIGS. 5-8, the seal 510 further includes a cover 534 on an end of the flexible body 514 nearest the lip 522, the cover 534 blocking access to the central passage 518 of the seal 510 from the end nearest the lip 522. In the embodiment illustrated in FIGS. 5-8, the cover 534 is integrally formed with the flexible body 514, lip 522 and other components of the seal 510 through molding or other suitable manufacturing processes. In other embodiments, the cover 534 could include a separate thin piece of material that is coupled to the flexible body 514 or lip 522.

The cover 534 is meant to provide additional protection to the dowel prior to installation at a rail site and to prevent liquids and other contaminants from entering the dowel or coming in contact with an interior of the seal 510. By reducing the thickness of the cover in a desired area, breakage or piercing of the cover may be controlled and eased during the process of installing the fastener. The breaking of the cover can be accomplished by pushing the fastener against the cover 534 in the area of a reduced-thickness portion 538. As shown in FIGS. 5 and 6, the reduced-thickness portion 538 of the cover 534 may be shaped as indicia to indicate a predetermined location for breakage of the cover 534. In the example illustrated, the indicia is provided in the shape of a cross or an “X”. Other suitable indicia may also be used to indicate the preferred region to break the cover 534. The thickness of the cover 534 in one embodiment may be approximately 0.025 inches nominal with a tolerance allowing 0.017 to 0.033 thickness. The depth of the reduced-thickness portion may be approximately 0.010 inches nominal with a tolerance allowing 0.004 to 0.016 depth, making the thickness of the cover 534 in the area of the reduced-thickness portion 538 about 0.015 inches nominal. In other embodiments, the thickness of the cover 534 and the reduced-thickness portion 538 may be greater or lesser than these amounts.

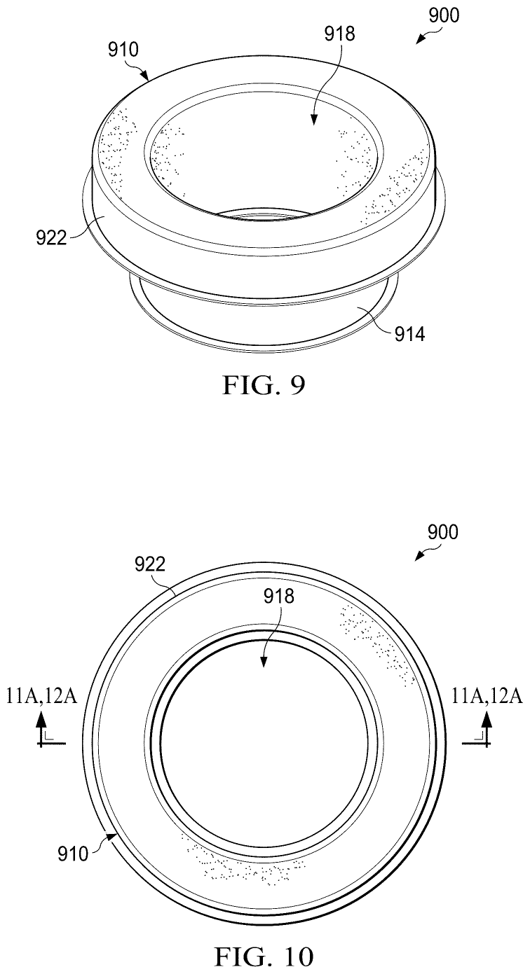

FIGS. 9 and 10 are an isometric front view and a top view, respectively, of a rail fastener sealing system 900 according to an embodiment. The rail fastener sealing system 900 may be a part of or cooperate with the other components of the rail systems described herein such as those in FIGS. 1-4. The rail fastener sealing system 900 includes a seal 910 having a flexible body 914 that includes a central passage 918. The flexible body 914 may be substantially cylindrical in shape with a lip 922 extending circumferentially around an opening of the passage 918. Seal 910 does not include a cover like that shown in FIGS. 5 and 6.

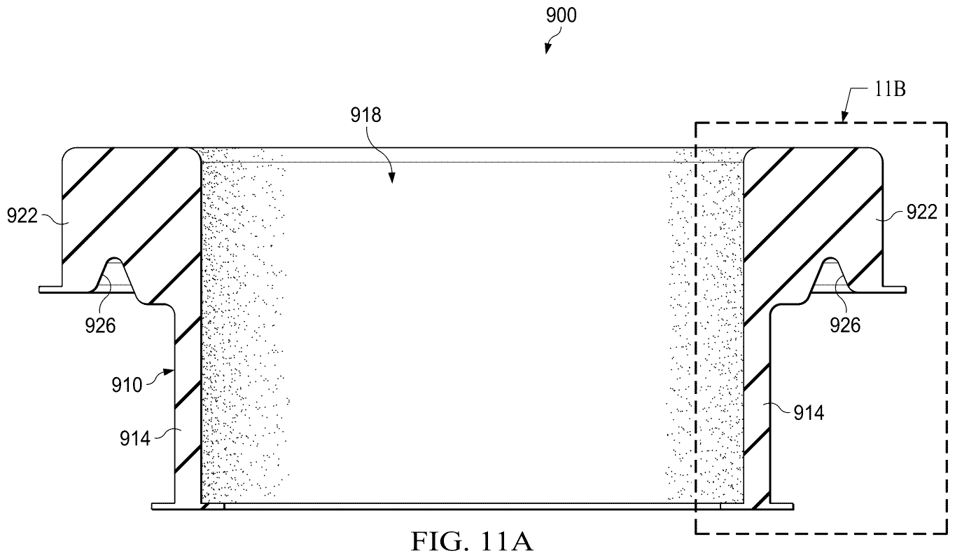

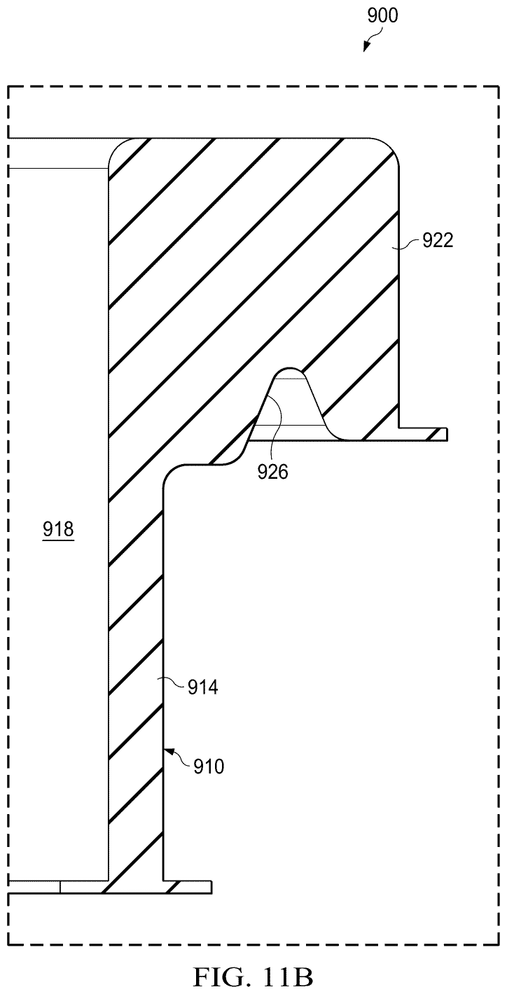

FIGS. 11A and 11B are cross-sectional front views of one embodiment of the lip 922 of seal 910. The lip 922 may include an inner channel 926 to receive a ridge or other protrusion that extends from an end surface of the dowel. The channel 926 may extend continuously and circumferentially around the lip 922, and may cooperate with the ridge or protrusions of the dowel to ensure the proper orientation of the seal 910 when installed on the dowel.

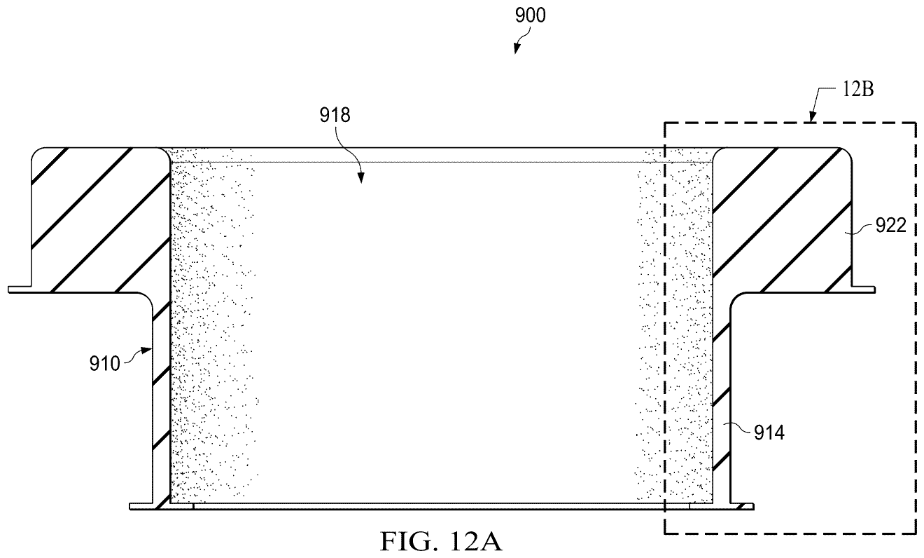

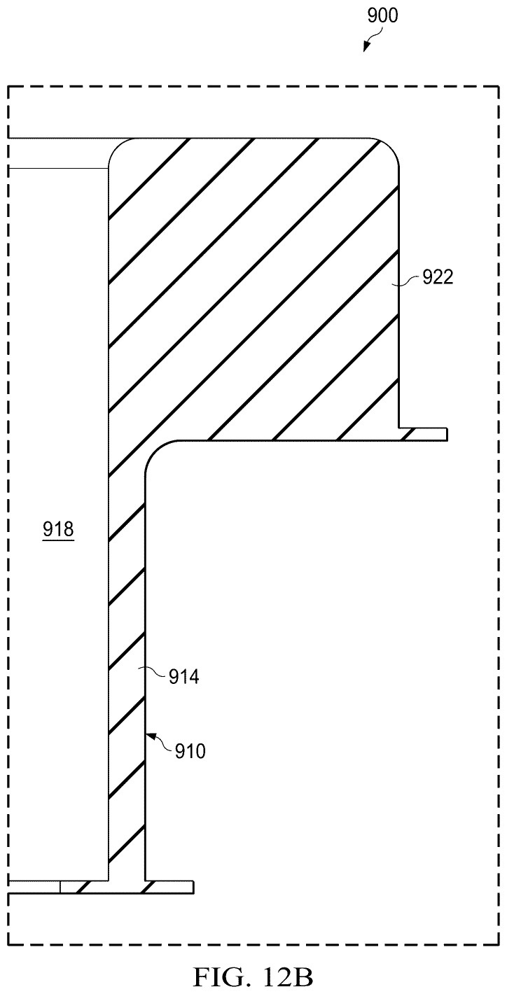

FIGS. 12A and 12B are cross-sectional front views of another embodiment of the lip 922 of seal 910. The lip 922 in FIGS. 12A and 12B does not include a channel or indentations and thus is meant to be used with dowels that do not have ridges, protrusions or other extensions on an end of the dowel.

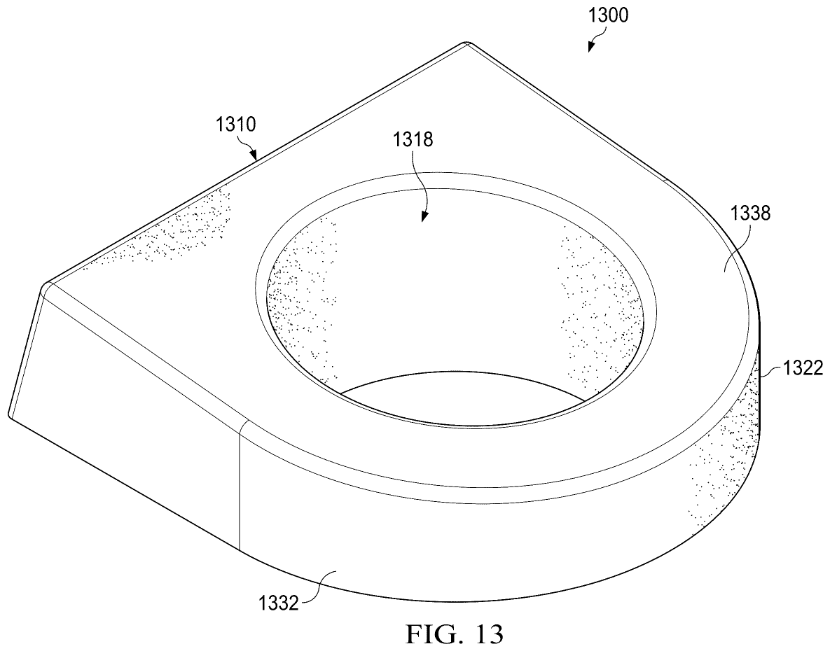

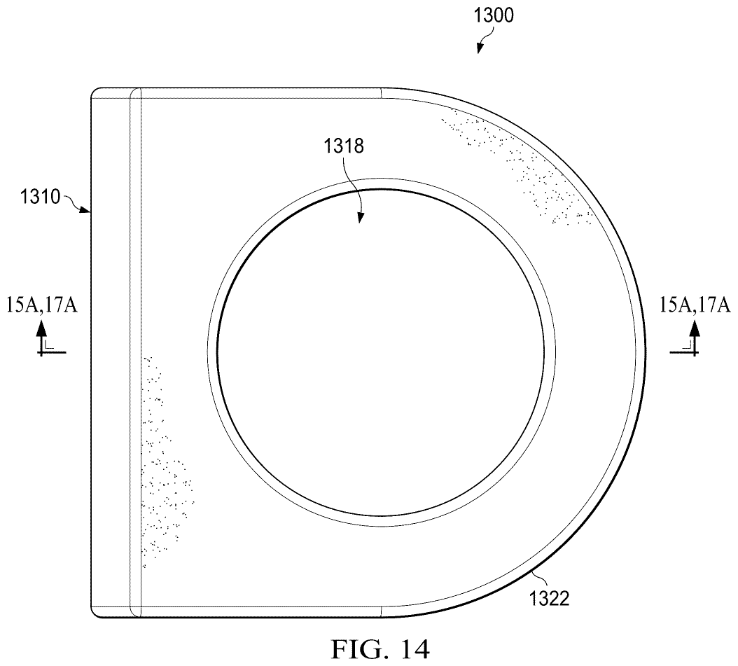

FIGS. 13, 14, and 16 are an isometric front view, a top view, and a bottom view, respectively, of a rail fastener sealing system 1300 according to an embodiment. The rail fastener sealing system 1300 may be a part of or cooperate with the other components of the rail systems described herein such as those in FIGS. 1-4. The rail fastener sealing system 1300 includes a seal 1310 having a flexible body 1314 that includes a central passage 1318. The flexible body 1314 may have a lip 1322 extending circumferentially around an opening of the passage 1318. While not shown the drawings, seal 1310 may in some embodiments include a cover similar to the cover shown in FIGS. 5 and 6.

While the lip 1322 extends around and surrounds the opening of the passage 1318, the lip 1322 is not circular in shape but rather D-shaped, with an arcuate surface 1332 and a planar surface 1334. The arcuate surface 1332 generally extends parallel to a central axis of the passage 1318, while the planar surface 1334 is angled relative to (and thus not parallel to) the central axis. The lip 1322 further includes an upper surface 1338 that may be formed at an angle that is not perpendicular to a central axis of the passage 1318. The D-shaped lip and angled surfaces allow the seal system 1310 to more closely confirm to structure surrounding the dowel 136 in FIGS. 1-3.

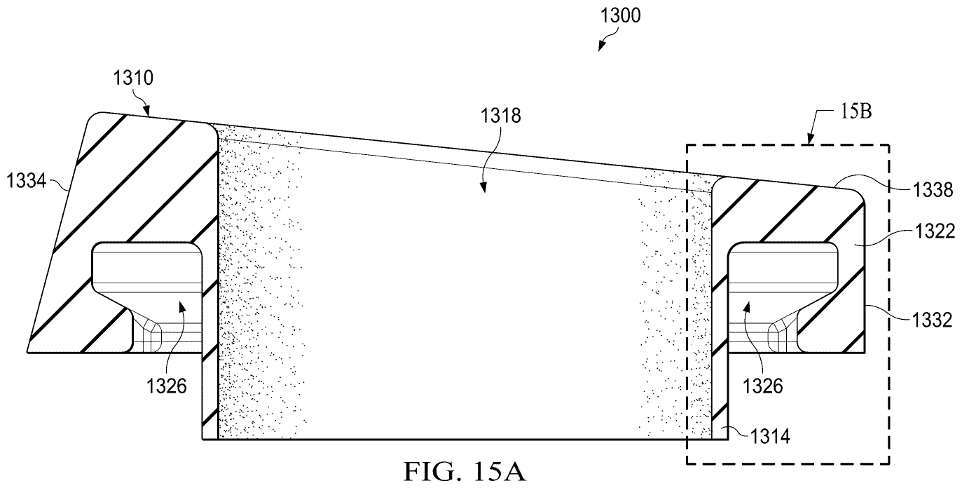

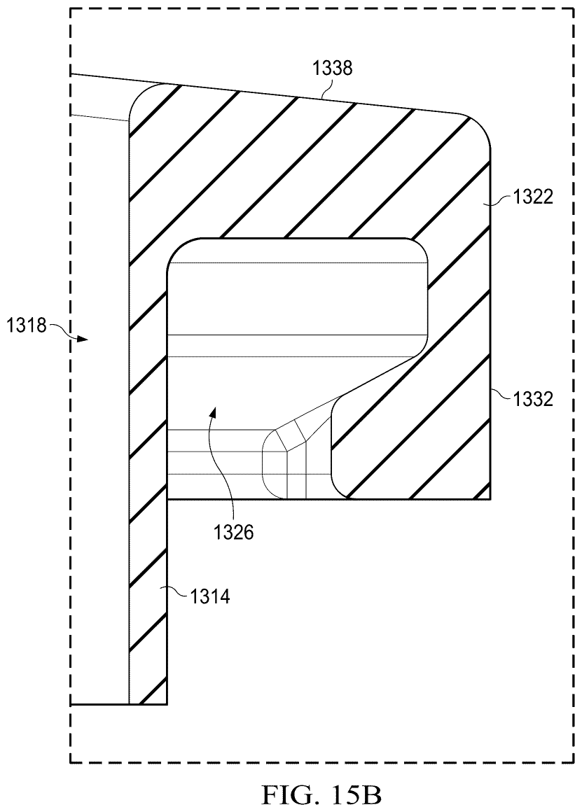

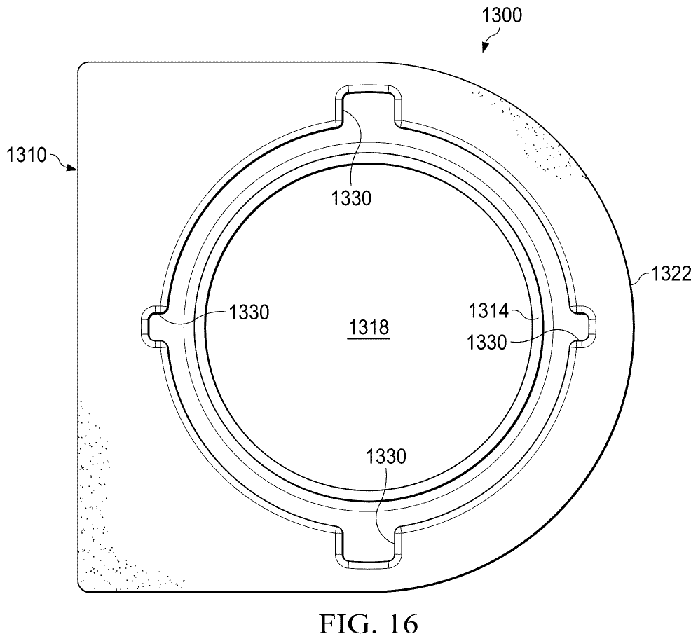

FIGS. 15A and 15B are cross-sectional front views of one embodiment of the lip 1322 of seal 1310. The lip 1322 includes an inner channel 1326 to receive the upper flange 144 of the dowel 136. A plurality of keyways 1330 (see FIG. 16) may also be formed in the lip 1322 to receive the key extensions 148 of the dowel 136, thus easily providing for the proper orientation of the seal system 1310 when installed on the dowel 136. In the illustrated embodiment, each keyway 1330 is diametrically opposed to the other keyways 1330, and the keyways 1330 are circumferentially spaced apart by ninety degrees.

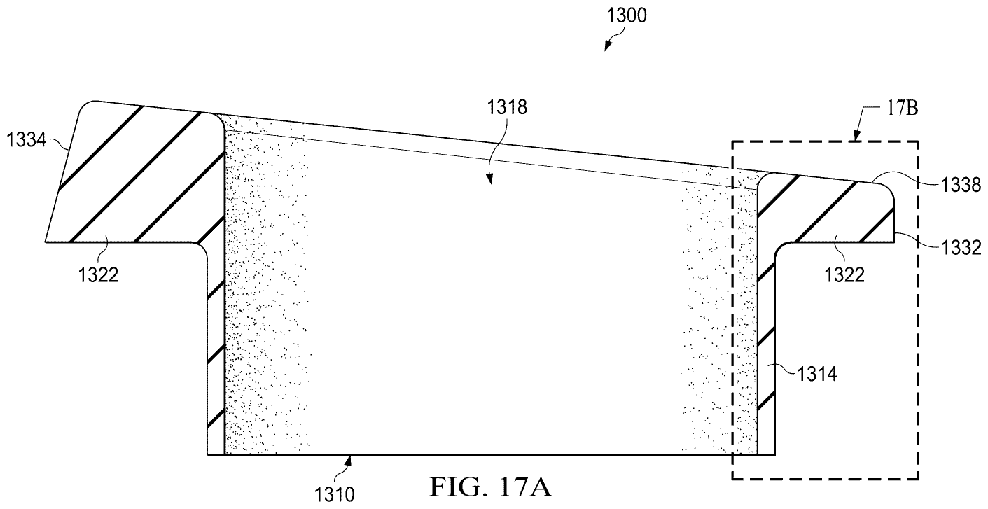

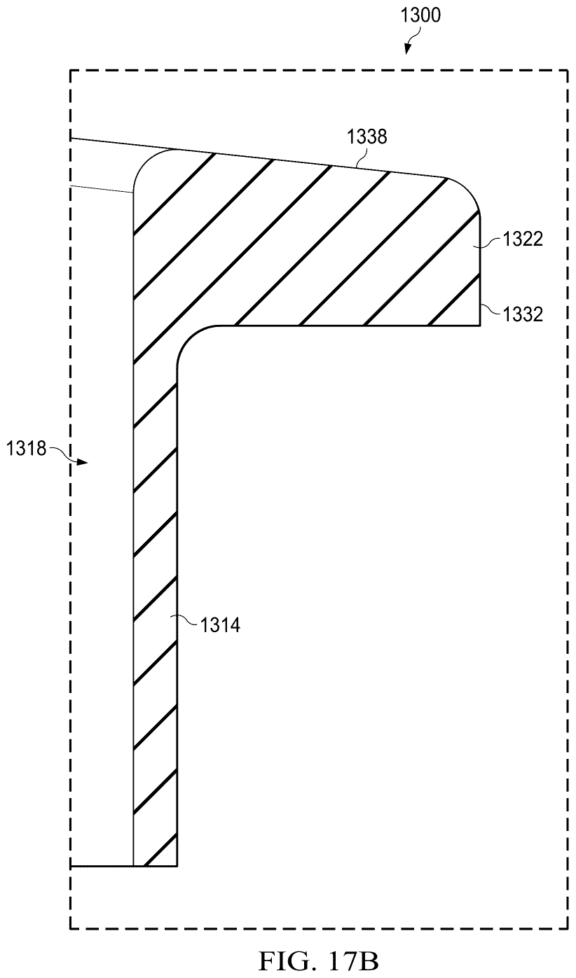

FIGS. 17A and 17B are cross-sectional front views of another embodiment of the lip 1322 of seal 1310. The lip 1322 in FIGS. 17A and 17B does not include a channel, indentations or keyways and thus is meant to be used with dowels that do not have ridges, flanges, protrusions or other extensions on an end of the dowel.

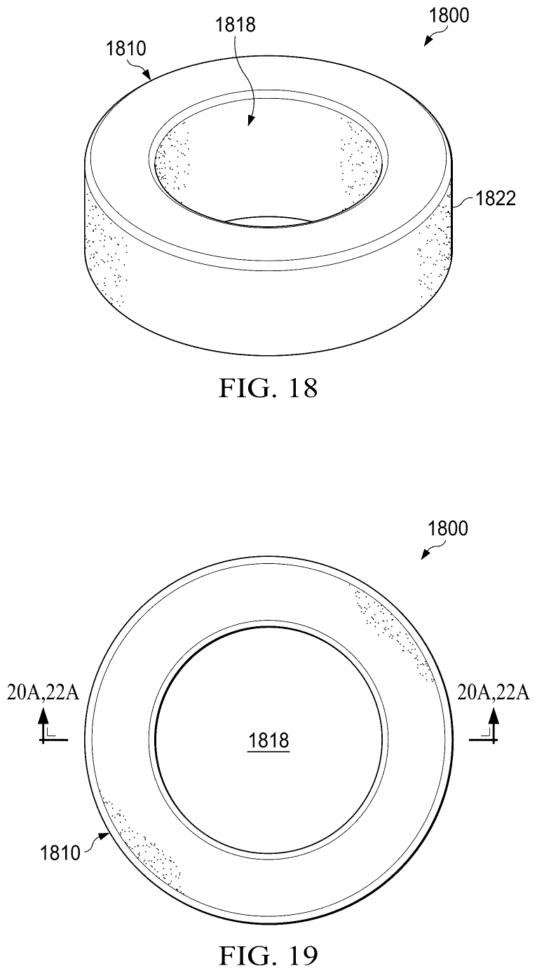

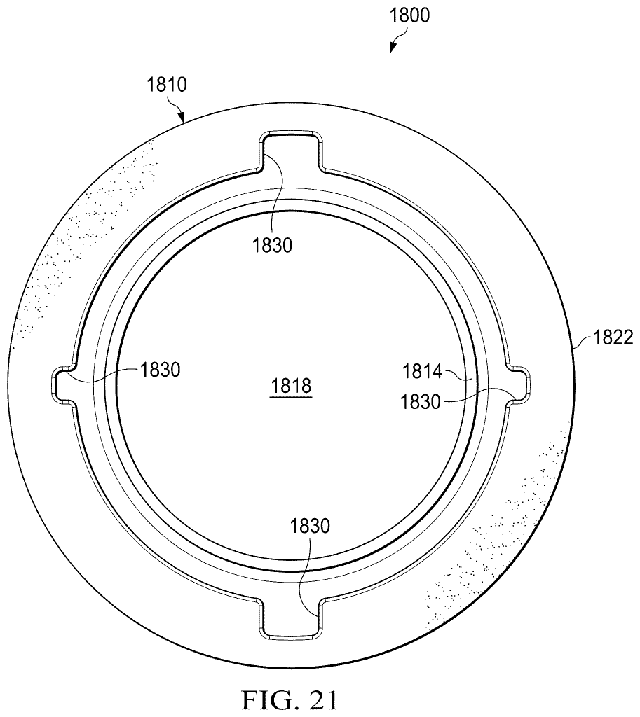

FIGS. 18, 19, and 21 are an isometric front view, a top view, and a bottom view, respectively, of a rail fastener sealing system 1800 according to an embodiment. The rail fastener sealing system 1800 may be a part of or cooperate with the other components of the rail systems described herein such as those in FIGS. 1-4. The rail fastener sealing system 1800 includes a seal 1810 having a flexible body 1814 that includes a central passage 1818.

The flexible body 1814 may be substantially cylindrical in shape with a lip 1822 extending circumferentially around an opening of the passage 1818. While not shown the drawings, seal 1810 may in some embodiments include a cover similar to the cover shown in FIGS. 5 and 6.

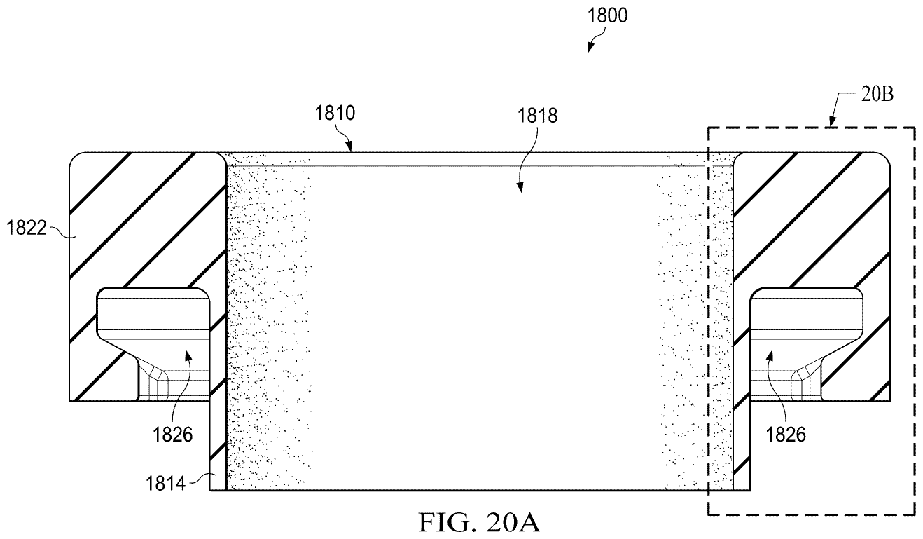

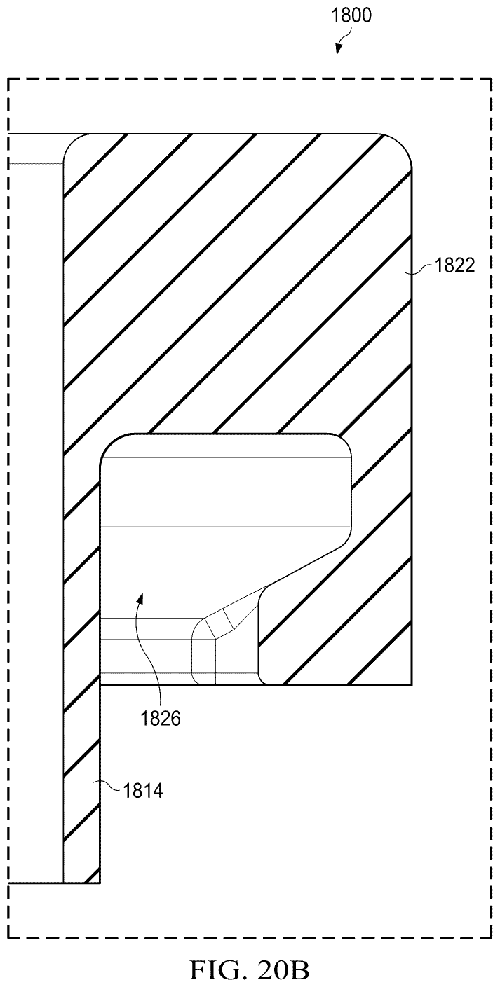

FIGS. 20A and 20B are cross-sectional front views of one embodiment of the lip 1822 of seal 1810. The lip 1822 includes an inner channel 1826 to receive the upper flange 144 of the dowel 136. A plurality of keyways 1830 (see FIG. 16) may also be formed in the lip 1822 to receive the key extensions 148 of the dowel 136, thus easily providing for the proper orientation of the seal system 1810 when installed on the dowel 136. In the illustrated embodiment, each keyway 1830 is diametrically opposed to the other keyways 1830, and the keyways 1830 are circumferentially spaced apart by ninety degrees.

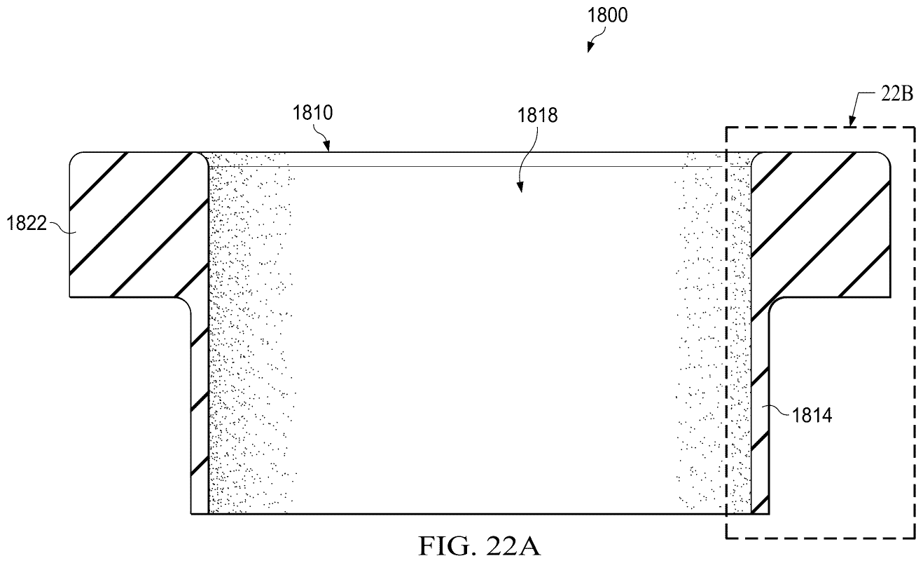

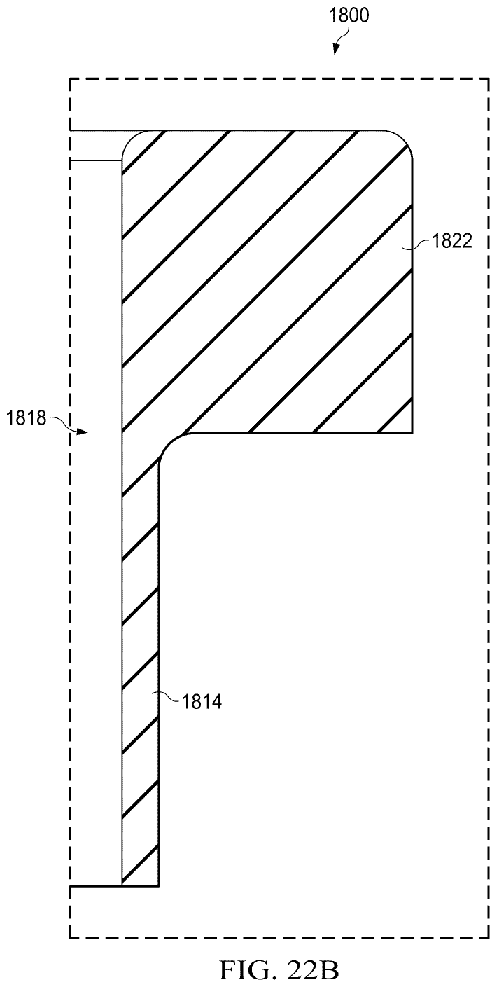

FIGS. 22A and 22B are cross-sectional front views of another embodiment of the lip 1822 of seal 1810. The lip 1822 in FIGS. 22A and 22B does not include a channel, indentations or keyways and thus is meant to be used with dowels that do not have ridges, flanges, protrusions or other extensions on an end of the dowel.

The seals of the rail fastener sealing systems described herein may be made from any material capable of sealing between the dowel, fastener, and any surrounding structure of the rail fastener assembly. In some embodiments, the seal may be formed from an elastomer, which may include without limitation a silicone-based polymer. Silicone polymers provide a strong and flexible seal that is also resistant to temperature fluctuations and exposure to ultraviolet light. In other embodiments, the seal system may be made from natural rubber, EPDM or other polymers.

In addition to the embodiments and examples of a rail fastener sealing system provided above, the following are illustrative examples of a rail fastener sealing system.

Example 1. A rail fastener sealing system comprising a dowel having a cylindrical elongated body and a dowel passage configured to receive a fastener that secures a rail to a rail tie, and a seal positioned on an end of the dowel. The seal comprises a flexible body having a central passage extending through the flexible body and a lip extending circumferentially around an opening of the central passage. The lip of the seal is disposed adjacent the end of the dowel and at least a portion of the flexible body of the seal is positioned within the dowel passage.

Example 2. The system of example 1, wherein the dowel includes a plurality of corrugations or threads on an interior of the cylindrical elongated body.

Example 3. The system of example 1 or 2, wherein the dowel includes an unthreaded portion on the interior of the cylindrical elongated body adjacent the end of the dowel.

Example 4. The system of any of examples 1-3, wherein the seal reduces ingress of a liquid into the dowel passage when the fastener is inserted within the dowel passage.

Example 5. The system of any of examples 1-4, wherein the dowel includes a plurality of corrugations or threads on an exterior of the cylindrical elongated body.

Example 6. The system of any of examples 1-5, wherein the seal further comprises a cover on an end of the flexible body nearest the lip, and the cover blocks access to the central passage of the seal from the end nearest the lip.

Example 7. The system of example 6, wherein the cover is integrally formed with the seal.

Example 8. The system of any of examples 1-7, wherein the lip of the seal includes a channel disposed in a lower surface of the lip.

Example 9. A rail fastener sealing system comprising a flexible body having a central passage extending through the flexible body; a lip extending circumferentially around an opening of the central passage; and a cover on an end of the flexible body nearest the lip, the cover blocking access to the central passage of the seal from the end nearest the lip.

Example 10. The system of example 9, wherein the cover is integrally formed with the seal.

Example 11. The system of example 9 or 10 further comprising a reduced-thickness portion of the cover that provides for controlled breakage or removal of the cover when the seal is in use.

Example 12. The system of example 11, wherein the reduced-thickness portion of the cover is shaped as indicia to indicate the predetermined location for breakage of the cover.

Example 13. The system of example 12, wherein the indicia is in the shape of a cross or an “X”.

Example 14. The system of any of examples 9-13, wherein the lip includes a channel disposed in the lip.

Example 15. A rail fastener sealing system comprising a substantially cylindrical, flexible body having a central passage extending through the flexible body, the central passage having a central axis; and a lip extending circumferentially around an opening of the central passage, the lip having an upper surface formed at an angle that is not perpendicular to the central axis of the central passage. The lip is D-shaped with an arcuate surface and a planar surface, the arcuate surface being substantially parallel to the central axis of the central passage, the planar surface being not parallel to the central axis.

Example 16. The system of example 15, wherein the lip includes a channel disposed in a lower surface of the lip.

Example 17. The seal system of example 15 or 16, wherein the lip includes an inner channel and at least one keyway formed in the lip.

Example 18. A method of sealing a rail fastening assembly, the method comprising inserting a dowel into a hole of a rail tie, the dowel having a substantially cylindrical elongated body forming a dowel passage; positioning a fastener into the dowel passage to secure a rail to the rail tie; and sealing between the dowel and the fastener to reduce ingress of a liquid between the dowel and the fastener.

Example 19. The method of example 18, wherein sealing further comprises providing a seal on an end of the dowel. The seal comprises a flexible body having a central passage extending through the flexible body, the central passage having a central axis; and a lip extending circumferentially around an opening of the central passage. The lip of the seal is disposed adjacent the end of the dowel and at least a portion of the flexible body of the seal is positioned within the dowel passage.

Example 20. The method of example 19, wherein prior to positioning a fastener into the dowel passage, the seal further comprises a cover on an end of the flexible body nearest the lip that blocks access to the central passage and the dowel passage from the end nearest the lip.

Example 21. The method of example 20, wherein positioning a fastener into the dowel passage further comprises breaking the cover to allow insertion of the fastener through the central passage and the dowel passage.

Although the present disclosure and its advantages have been described in detail, it should be understood that various changes, substitutions and alterations can be made herein without departing from the spirit and scope of the disclosure as defined by the following claims.

What is claimed is:

1. A rail fastener sealing system comprising:
a dowel having a cylindrical elongated body and a dowel passage configured to receive a fastener that secures a rail to a rail tie;
a seal positioned on an end of the dowel, the seal comprising:
a flexible body having a central passage extending through the flexible body; and
a lip extending circumferentially around an opening of the central passage;
wherein the lip of the seal is disposed adjacent the end of the dowel and at least a portion of the flexible body of the seal is positioned within the dowel passage.

2. The system of claim 1, wherein the dowel includes a plurality of corrugations or threads on an interior of the cylindrical elongated body.

3. The system of claim 2, wherein the dowel includes an unthreaded portion on the interior of the cylindrical elongated body adjacent the end of the dowel.

4. The system of claim 1, wherein the seal reduces ingress of a liquid into the dowel passage when the fastener is inserted within the dowel passage.

5. The system of claim 1, wherein the dowel includes a plurality of corrugations or threads on an exterior of the cylindrical elongated body.

6. The system of claim 1, wherein:
the seal further comprises a cover on an end of the flexible body nearest the lip; and
the cover blocks access to the central passage of the seal from the end nearest the lip.

7. The system of claim 6, wherein the cover is integrally formed with the seal.

8. The system of claim 1, wherein the lip of the seal includes a channel disposed in a lower surface of the lip.

9. A rail fastener sealing system comprising:
a flexible body having a central passage extending through the flexible body;
a lip extending circumferentially around an opening of the central passage; and
a cover on an end of the flexible body nearest the lip, the cover blocking access to the central passage of the seal from the end nearest the lip.

10. The system of claim 9, wherein the cover is integrally formed with the seal.

11. The system of claim 9 further comprising:
a reduced-thickness portion of the cover that provides for controlled breakage or removal of the cover when the seal is in use.

12. The system of claim 11, wherein the reduced-thickness portion of the cover is shaped as indicia to indicate the predetermined location for breakage of the cover.

13. The system of claim 12, wherein the indicia is in the shape of a cross or an “X”.

14. The system of claim 9, wherein the lip includes a channel disposed in a lower surface of the lip.

15. A rail fastener sealing system comprising:
a substantially cylindrical, flexible body having a central passage extending through the flexible body, the central passage having a central axis; and
a lip extending circumferentially around an opening of the central passage, the lip having an upper surface formed at an angle that is not perpendicular to the central axis of the central passage;
wherein the lip is D-shaped with an arcuate surface and a planar surface, the arcuate surface being substantially parallel to the central axis of the central passage, the planar surface being not parallel to the central axis.

16. The system of claim 15, wherein the lip includes a channel disposed in a lower surface of the lip.

17. The seal system of claim 15, wherein the lip includes an inner channel and at least one keyway formed in the lip.

18. A method of sealing a rail fastening assembly, the method comprising:
inserting a dowel into a hole of a rail tie, the dowel having a substantially cylindrical elongated body forming a dowel passage;
positioning a fastener into the dowel passage to secure a rail to the rail tie; and
sealing between the dowel and the fastener to reduce ingress of a liquid between the dowel and the fastener.

19. The method of claim 18, wherein sealing further comprises:
providing a seal on an end of the dowel, the seal comprising:
a flexible body having a central passage extending through the flexible body, the central passage having a central axis; and
a lip extending circumferentially around an opening of the central passage;
wherein the lip of the seal is disposed adjacent the end of the dowel and at least a portion of the flexible body of the seal is positioned within the dowel passage.

20. The method of claim 19, wherein prior to positioning a fastener into the dowel passage, the seal further comprises:
a cover on an end of the flexible body nearest the lip that blocks access to the central passage and the dowel passage from the end nearest the lip.

21. The method of claim 20, wherein positioning a fastener into the dowel passage further comprises:
breaking the cover to allow insertion of the fastener through the central passage and the dowel passage.
